(19) United States
(12) Patent Application Publication
(10) Pub. No.: US 2024/0016138 A1
(43) Pub. Date: Jan. 18, 2024

(54) UNMANNED VEHICLE MANAGEMENT SYSTEM AND UNMANNED VEHICLE MANAGEMENT METHOD

(71) Applicant: Komatsu Ltd., Tokyo (JP)

(72) Inventors: Kazuma Takeda, Tokyo (JP); Takashi Hiranaka, Tokyo (JP); Kenta Osagawa, Tokyo (JP)

(73) Assignee: Komatsu Ltd., Tokyo (JP)

(21) Appl. No.: 18/268,365

(22) PCT Filed: Jan. 20, 2022
(86) PCT No.: PCT/JP2022/002043

§ 371 Date: Jun. 20, 2023

(30) Foreign Application Priority Data
Feb. 17, 2021 (JP) 2021-023450

(51) Int. Cl. A01M 7/00; G05D 1/02

(52) U.S. Cl. CPC A01M 7/0089; G05D 1/0214

(57) ABSTRACT

An unmanned vehicle management system includes: a protection area setting unit that sets a protection area where entry of an unmanned vehicle traveling around a sprinkler vehicle is prohibited on the basis of a sprinkling state of a sprinkle spray provided in the sprinkler vehicle moving at a work site; and an output unit that outputs the protection area set by the protection area setting unit.

### FIELD

The present disclosure relates to an unmanned vehicle management system and an unmanned vehicle management method.

### BACKGROUND

In order to suppress dispersion of dirt or dust at a work site, there is a case where sprinkling is performed by a sprinkler vehicle. Patent Literature 1 discloses a mobile fluid transporter that transports a fluid to a site.

### CITATION LIST

### Patent Literature

Patent Literature 1: JP 2013-516557 A

### Summary

### Technical Problem

In a wide-area work site such as a mine, an unmanned vehicle operates. When the unmanned vehicle excessively approaches a sprinkler vehicle during sprinkling, there is a possibility that traveling of an unmanned vehicle existing around the sprinkler vehicle is hindered.

An object of the present disclosure is to suppress an effect of a sprinkler vehicle during sprinkling on a surrounding unmanned vehicle.

### Solution to Problem

According to an aspect of the present invention, an unmanned vehicle management system comprises: a protection area setting unit that sets a protection area where entry of an unmanned vehicle traveling around a sprinkler vehicle is prohibited on the basis of a sprinkling state of a sprinkle spray provided in the sprinkler vehicle moving at a work site; and an output unit that outputs the protection area set by the protection area setting unit.

### Advantageous Effects of Invention

According to the present disclosure, it is possible to suppress an effect of a sprinkler vehicle during sprinkling on a surrounding unmanned vehicle.

### BRIEF DESCRIPTION OF DRAWINGS

FIG. 1 is a schematic diagram illustrating a management system at a work site according to an embodiment.

FIG. 2 is a perspective diagram illustrating an unmanned haul vehicle according to an embodiment.

FIG. 3 is a perspective diagram illustrating an unmanned sprinkler vehicle according to an embodiment.

FIG. 4 is a schematic diagram illustrating a work site according to an embodiment.

FIG. 5 is a functional block diagram illustrating a management system at a work site according to an embodiment.

FIG. 6 is a diagram for describing first course data and a protection area of the unmanned haul vehicle according to an embodiment.

FIG. 7 is a diagram for describing second course data and a protection area of the unmanned sprinkler vehicle according to an embodiment.

FIG. 8 is a diagram for describing a sprinkling state of a sprinkle spray according to an embodiment.

FIG. 9 is a diagram for describing processing of a second protection area setting unit according to an embodiment.

FIG. 10 is a diagram for describing processing of the second protection area setting unit according to an embodiment.

FIG. 11 is a diagram illustrating a relationship between the unmanned sprinkler vehicle and the unmanned haul vehicle according to an embodiment.

FIG. 12 is a flowchart illustrating an unmanned vehicle management method according to an embodiment.

FIG. 13 is a diagram for describing a sprinkling state of a sprinkle spray according to an embodiment.

FIG. 14 is a diagram for describing a sprinkling state of a sprinkle spray according to an embodiment.

### DESCRIPTION OF EMBODIMENTS

Hereinafter, an embodiment according to the present disclosure will be described with reference to the drawings, but the present disclosure is not limited to the embodiment. Components of the embodiment described below can be appropriately combined. In addition, some components may not be used.

[Overview of Management System]

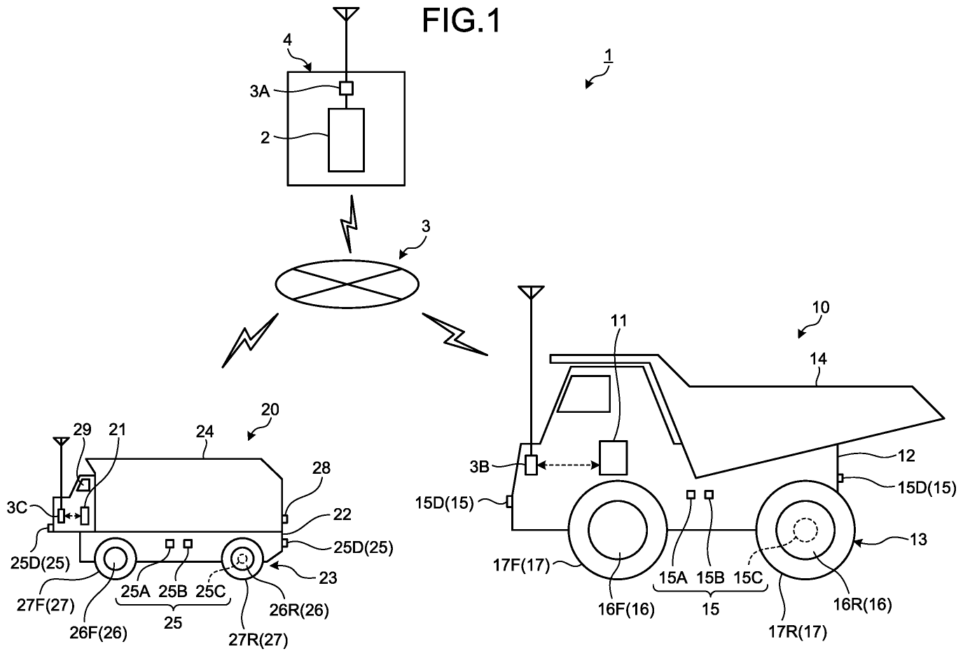

FIG. 1 is a schematic diagram illustrating an unmanned vehicle management system 1 according to the embodiment. The management system 1 manages an unmanned vehicle operating at a work site. The unmanned vehicle refers to a work vehicle that operates in an unmanned manner without depending on a driving manipulation by a driver. In the embodiment, the unmanned vehicle operating at a work site includes a first unmanned vehicle 10 and a second unmanned vehicle 20.

In the embodiment, the first unmanned vehicle 10 is an unmanned haul vehicle. The second unmanned vehicle 20 is an unmanned sprinkler vehicle. In the following description, the first unmanned vehicle 10 is appropriately referred to as an unmanned haul vehicle 10, and the second unmanned vehicle 20 is appropriately referred to as an unmanned sprinkler vehicle 20.

The unmanned haul vehicle 10 travels in an unmanned manner at a work site to haul a load. An unmanned dump truck is exemplified as the unmanned haul vehicle 10. An excavated object excavated at a work site is exemplified as a load to be hauled to the unmanned haul vehicle 10.

The unmanned sprinkler vehicle 20 travels in an unmanned manner at a work site to sprinkle water. An unmanned sprinkling truck is exemplified as the unmanned sprinkler vehicle 20. The unmanned sprinkler vehicle 20 sprinkles water to suppress dispersion of dirt or dust at the work site.

The management system 1 includes a management device 2 and a communication system 3. The management device 2 is installed in a control facility 4 of the work site. There is a manager in the control facility 4.

The unmanned haul vehicle 10 includes a control device 11. The unmanned sprinkler vehicle 20 includes a control device 21. The management device 2, the control device 11, and the control device 21 wirelessly communicate with each other via the communication system 3. A wireless communicator 3A is connected to the management device 2. A wireless communicator 3B is connected to the control device 11. A wireless communicator 3C is connected to the control device 21. The communication system 3 includes the wireless communicator 3A, the wireless communicator 3B, and the wireless communicator 3C.

[Unmanned Haul Vehicle]

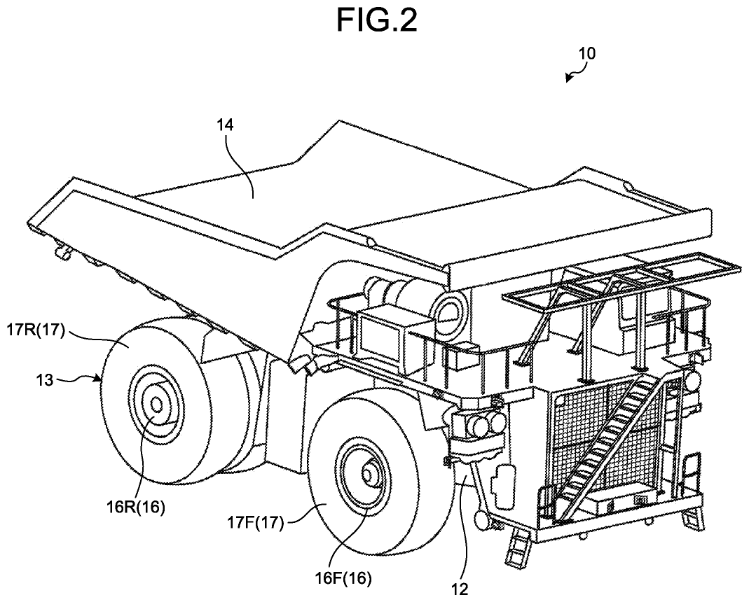

FIG. 2 is a perspective diagram illustrating the unmanned haul vehicle 10 according to the embodiment. As illustrated in FIGS. 1 and 2, the unmanned haul vehicle 10 includes the wireless communicator 3B, the control device 11, a vehicle body 12, a traveling device 13, a dump body 14, and a sensor system 15.

The vehicle body 12 includes a vehicle body frame. The vehicle body 12 is supported by the traveling device 13. The vehicle body 12 supports the dump body 14.

The traveling device 13 generates a driving force for causing the unmanned haul vehicle 10 to travel. The traveling device 13 generates a braking force for decelerating or stopping the unmanned haul vehicle 10. The traveling device 13 generates a steering force for turning the unmanned haul vehicle 10. The traveling device 13 moves the unmanned haul vehicle 10 forward or backward. The traveling device 13 includes wheels 16. Tires 17 are mounted on the wheels 16. The wheels 16 include front wheels 16F and rear wheels 16R. The tires 17 include front tires 17F mounted on the front wheels 16F and rear tires 17R mounted on the rear wheels 16R. The wheels 16 rotate in a state where the tires 17 are in contact with the road surface of the work site, and the unmanned haul vehicle 10 travels at the work site.

The dump body 14 is a member on which a load is loaded. At least a part of the dump body 14 is disposed above the vehicle body 12.

The sensor system 15 includes a position sensor 15A, an orientation sensor 15B, a speed sensor 15C, and an obstacle sensor 15D. The position sensor 15A detects the position of the unmanned haul vehicle 10. The position of the unmanned haul vehicle 10 is detected using a global navigation satellite system (GNSS). The position sensor 15A includes a GNSS receiver and detects the position of the unmanned haul vehicle 10 in a global coordinate system. The orientation sensor 15B detects the orientation of the unmanned haul vehicle 10. A gyro sensor is exemplified as the orientation sensor 15B. The speed sensor 15C detects the traveling speed of the unmanned haul vehicle 10. As the speed sensor 15C, a pulse sensor that detects the rotation of the wheels 16 is exemplified. The obstacle sensor 15D detects an obstacle around the unmanned haul vehicle 10. The obstacle sensor 15D detects an obstacle in a non-contact manner. Examples of the obstacle sensor 15D include a laser sensor (light detection and ranging (LIDAR)) and a radar sensor (radio detection and ranging (RADAR)).

[Unmanned Sprinkler Vehicle]

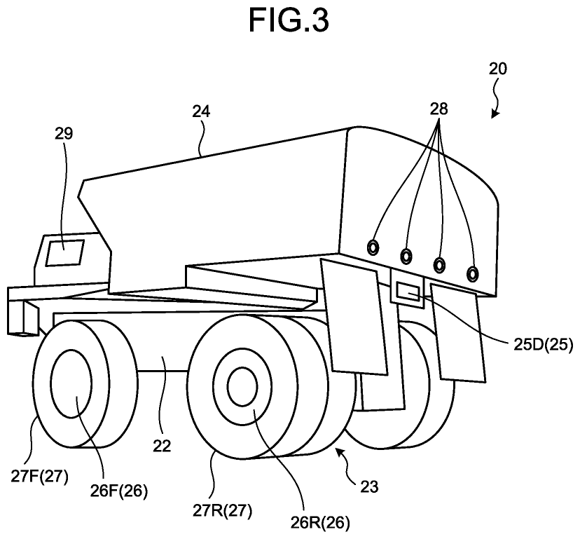

FIG. 3 is a perspective diagram illustrating the unmanned sprinkler vehicle 20 according to the embodiment. As illustrated in FIGS. 1 and 3, the unmanned sprinkler vehicle 20 includes the wireless communicator 3C, the control device 21, a vehicle body 22, a traveling device 23, a tank 24, a sensor system 25, and a sprinkle spray 28.

The vehicle body 22 includes a vehicle body frame. The vehicle body 22 is supported by the traveling device 23. The vehicle body 22 supports the tank 24.

In the embodiment, a cab 29 is provided in the vehicle body 22. The cab 29 is provided at a front portion of the vehicle body 22. The driver can board the cab 29 and perform the driving manipulation of the unmanned sprinkler vehicle 20. For example, when performing maintenance or inspection of the unmanned sprinkler vehicle 20, the driver performs the driving manipulation of the unmanned sprinkler vehicle 20. In the embodiment, the unmanned sprinkler vehicle 20 operates in an unmanned manner at least when sprinkling water at the work site. Note that the cab 29 may not be provided in the unmanned sprinkler vehicle 20.

The traveling device 23 generates a driving force for causing the unmanned sprinkler vehicle 20 to travel. The traveling device 23 generates a braking force for decelerating or stopping the unmanned sprinkler vehicle 20. The traveling device 23 generates a steering force for turning the unmanned sprinkler vehicle 20. The traveling device 23 moves the unmanned sprinkler vehicle 20 forward or backward. The traveling device 23 includes wheels 26. Tires 27 are mounted on the wheels 26. The wheels 26 include front wheels 26F and rear wheels 26R. The front wheels 26F are steering wheels, and the rear wheels 26R are driving wheels. Note that both the front wheels 26F and the rear wheels 26R may be steering wheels. Both the front wheels 26F and the rear wheels 26R may be driving wheels. The front wheels 26F may be driving wheels and the rear wheels 26R may be steering wheels. The tires 27 include front tires 27F mounted on the front wheels 26F and rear tires 27R mounted on the rear wheels 26R. The wheels 26 rotate in a state where the tires 27 are in contact with the road surface of the work site, and the unmanned sprinkler vehicle 20 travels at the work site.

The tank 24 is a member that stores water for sprinkling. At least a part of the tank 24 is disposed above the vehicle body 22.

The sensor system 25 includes a position sensor 25A, an orientation sensor 25B, a speed sensor 25C, and an obstacle sensor 25D. The position sensor 25A detects the position of the unmanned sprinkler vehicle 20. The position of the unmanned sprinkler vehicle 20 is detected using a global navigation satellite system (GNSS). The position sensor 25A includes a GNSS receiver and detects the position of the unmanned sprinkler vehicle 20 in a global coordinate system. The orientation sensor 25B detects the orientation of the unmanned sprinkler vehicle 20. A gyro sensor is exemplified as the orientation sensor 25B. The speed sensor 25C detects the traveling speed of the unmanned sprinkler vehicle 20. As the speed sensor 25C, a pulse sensor that detects the rotation of the wheels 26 is exemplified. The obstacle sensor 25D detects an obstacle around the unmanned sprinkler vehicle 20. The obstacle sensor 25D detects an obstacle in a non-contact manner. Examples of the obstacle sensor 25D include a laser sensor (light detection and ranging (LIDAR)) and a radar sensor (radio detection and ranging (RADAR)).

The sprinkle spray 28 sprays water in the tank 24. The sprinkle spray 28 is disposed at a rear portion of the unmanned sprinkler vehicle 20. In the embodiment, the sprinkle spray 28 is disposed at a rear portion of the tank 24. The sprinkle spray 28 sprinkles water behind the unmanned sprinkler vehicle 20. In the embodiment, a plurality of sprinkle sprays 28 is provided. The plurality of sprinkle sprays 28 is disposed at intervals in a vehicle width direction of the unmanned sprinkler vehicle 20 at the rear portion of the tank 24. The vehicle width direction refers to a direction parallel to a rotation axis of the wheels 26 when the unmanned sprinkler vehicle 20 is in a straight traveling state.

[Work Site]

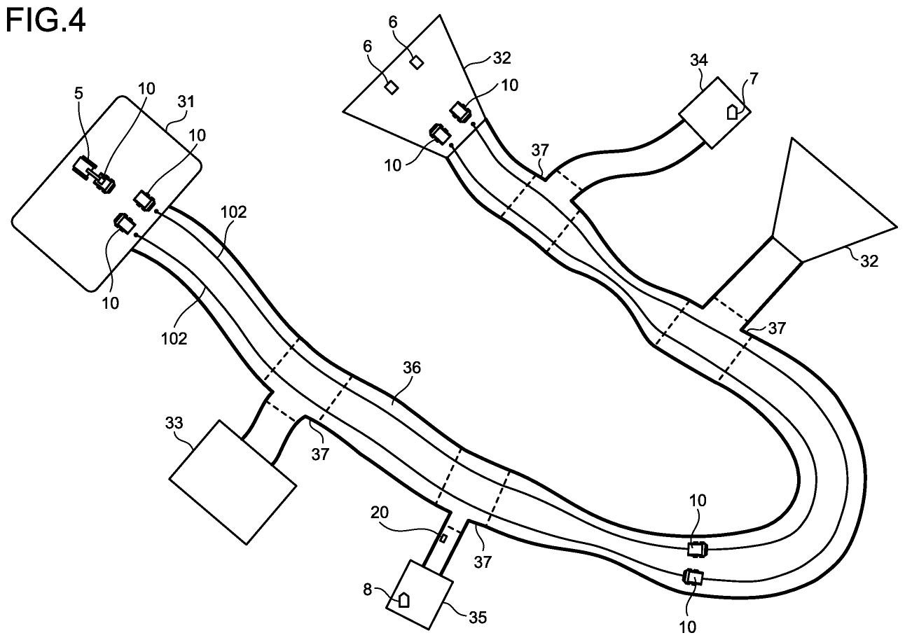

FIG. 4 is a schematic diagram illustrating a work site according to the embodiment. Examples of the work site include a mine or a quarry. The mine refers to a place or premises where minerals are mined. The quarry refers to a place or premises where stones are mined. At the work site, each of the unmanned haul vehicle 10 and the unmanned sprinkler vehicle 20 operates.

In the embodiment, the work site is a mine. Examples of the mine include a metal mine for mining metal, a non-metal mine for mining limestone, and a coal mine for mining coal.

At the work site, a loading area 31, a discharging area 32, a parking area 33, a fuel supply area 34, a water supply area 35, a traveling path 36, and intersections 37 are provided.

The loading area 31 is an area in which a loading work of loading a load on the unmanned haul vehicle 10 is performed. In the loading area 31, a loader 5 operates. As the loader 5, an excavator is exemplified.

The discharging area 32 refers to an area where a discharging work of discharging a load from the unmanned haul vehicle 10 is performed. A crusher 6 is provided in the discharging area 32.

The parking area 33 is an area where at least one of the unmanned haul vehicle 10 and the unmanned sprinkler vehicle 20 is parked.

The fuel supply area 34 is an area where at least one of the unmanned haul vehicle 10 and the unmanned sprinkler vehicle 20 is supplied with fuel. A fuel supplier 7 that supplies fuel is provided in the fuel supply area 34.

The water supply area 35 is an area where the unmanned sprinkler vehicle 20 is supplied with water. In the water supply area 35, water for sprinkling is supplied to the tank 24. In the water supply area 35, a water supplier 8 that supplies water to the tank 24 is provided.

The traveling path 36 refers to an area where an unmanned vehicle travels toward at least one of the loading area 31, the discharging area 32, the parking area 33, the fuel supply area 34, and the water supply area 35. The traveling path 36 is provided so as to connect at least the loading area 31 and the discharging area 32. In the embodiment, the traveling path 36 is connected to each of the loading area 31, the discharging area 32, the parking area 33, the fuel supply area 34, and the water supply area 35.

The intersections 37 refer to an area where a plurality of traveling paths 36 intersects or an area where one traveling path 36 branches into a plurality of traveling paths 36.

[Management System]

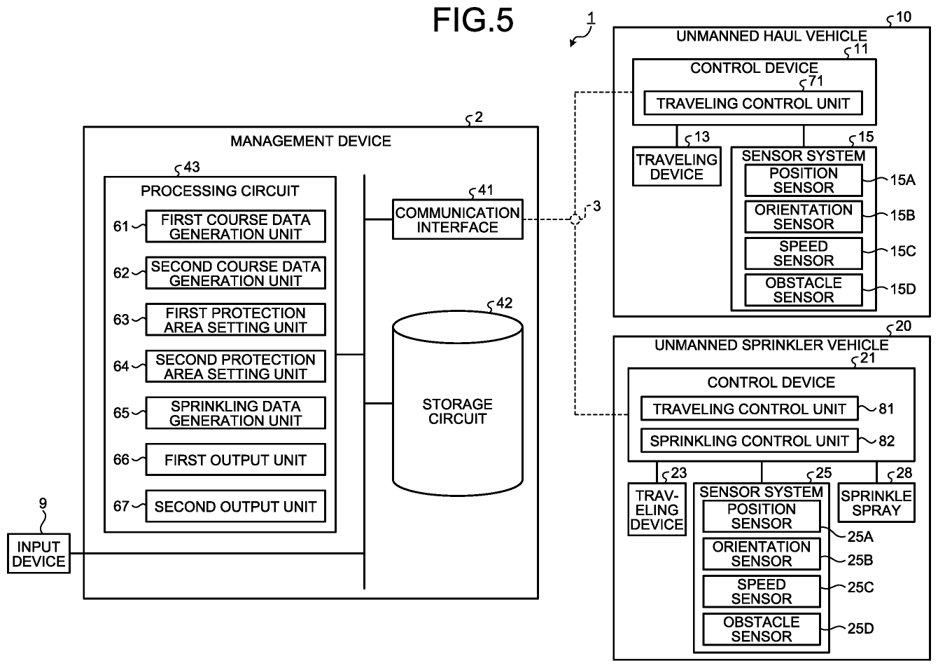

FIG. 5 is a functional block diagram illustrating the management system 1 at a work site according to the embodiment. The management system 1 includes the management device 2, the communication system 3, the control device 11, and the control device 21.

The management device 2 includes a computer system. The management device 2 is connected to an input device 9. The management device 2 includes a communication interface 41, a storage circuit 42, and a processing circuit 43.

The input device 9 is connected to the processing circuit 43. The input device 9 is manipulated by the manager of the control facility 4. The input device 9 generates input data on the basis of a manipulation of the manager. The input data generated by the input device 9 is input to the processing circuit 43. Examples of the input device 9 include a touch panel, a computer keyboard, a mouse, and a manipulation button. Note that the input device 9 may be a non-contact type input device including an optical sensor, or may be a voice input device.

The communication interface 41 is connected to the processing circuit 43. The communication interface 41 controls communication between the management device 2 and at least one of the control device 11 and the control device 21. The communication interface 41 communicates with at least one of the control device 11 and the control device 21 via the communication system 3.

The storage circuit 42 is connected to the processing circuit 43. The storage circuit 42 stores data. As the storage circuit 42, nonvolatile memory or volatile memory is exemplified. Examples of the nonvolatile memory include read only memory (ROM) and a storage. Examples of the storage include a hard disk drive (HDD) and a solid state drive (SSD). As the volatile memory, random access memory (RAM) is exemplified.

The processing circuit 43 performs arithmetic processing and control command output processing. A processor is exemplified as the processing circuit 43. Examples of the processor include a central processing unit (CPU) and a micro processing unit (MPU). A computer program is stored in the storage circuit 42. The processing circuit 43 exerts a predetermined function by acquiring and executing the computer program from the storage circuit 42.

The processing circuit 43 includes a first course data generation unit 61, a second course data generation unit 62, a first protection area setting unit 63, a second protection area setting unit 64, a sprinkling data generation unit 65, a first output unit 66, and a second output unit 67.

The first course data generation unit 61 generates first course data indicating a traveling condition of the unmanned haul vehicle 10 set at the work site. The first course data generation unit 61 may generate the first course data on the basis of the input data from the input device 9.

The second course data generation unit 62 generates second course data indicating a traveling condition of the unmanned sprinkler vehicle 20 set at the work site. The second course data generation unit 62 may generate the second course data on the basis of the input data from the input device 9.

The first protection area setting unit 63 sets a protection area 103 permitting the unmanned haul vehicle 10 to travel at least in front of the unmanned haul vehicle 10.

The second protection area setting unit 64 sets a protection area 203 permitting the unmanned sprinkler vehicle 20 to travel at least in front of the unmanned sprinkler vehicle 20.

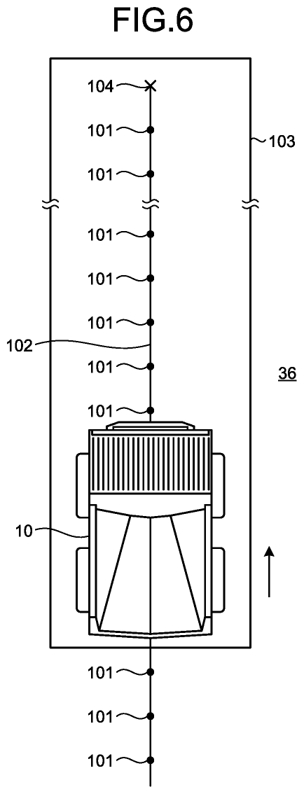

FIG. 6 is a diagram for describing the first course data and the protection area 103 of the unmanned haul vehicle 10 according to the embodiment. The first course data defines a traveling condition of the unmanned haul vehicle 10. The first course data includes course points 101, a traveling course 102, a target position of the unmanned haul vehicle 10, a target orientation of the unmanned haul vehicle 10, and a target traveling speed of the unmanned haul vehicle 10.

A plurality of course points 101 is set on the traveling path 36 including the intersections 37. In addition, the plurality of course points 101 is set in each of the loading area 31, the discharging area 32, the parking area 33, and the fuel supply area 34. The course points 101 define the target position of the unmanned haul vehicle 10. The target orientation and target traveling speed of the unmanned haul vehicle 10 are set for each of the plurality of course points 101. The plurality of course points 101 is set at intervals. The intervals between the course points 101 are set to, for example, 1 [m] or more and 5 [m] or less. The intervals between the course points 101 may be uniform or non-uniform.

The traveling course 102 refers to a virtual line indicating a target traveling path of the unmanned haul vehicle 10. The traveling course 102 is defined by a trajectory passing through the plurality of course points 101. The unmanned haul vehicle 10 travels at the work site along the traveling course 102.

The target position of the unmanned haul vehicle 10 refers to a target position of the unmanned haul vehicle 10 when passing through the course point 101. The target position of the unmanned haul vehicle 10 may be defined in a local coordinate system of the unmanned haul vehicle 10 or may be defined in a global coordinate system.

The target orientation of the unmanned haul vehicle 10 refers to a target orientation of the unmanned haul vehicle 10 when passing through the course point 101.

The target traveling speed of the unmanned haul vehicle 10 refers to a target traveling speed of the unmanned haul vehicle 10 when passing through the course point 101. The target traveling speed of the unmanned haul vehicle 10 includes an upper limit speed (limit speed) indicating an upper limit of the traveling speed of the unmanned haul vehicle 10. The unmanned haul vehicle 10 travels at a traveling speed not exceeding the upper limit speed at the work site.

The protection area 103 is an area where the unmanned haul vehicle 10 is permitted to travel. In addition, the protection area 103 is an area where entry of another unmanned haul vehicle 10 and the unmanned sprinkler vehicle 20 traveling around the unmanned haul vehicle 10 is prohibited. That is, the protection area 103 functions as a permission area where the unmanned haul vehicle 10 is permitted to travel. The protection area 103 functions as an entry prohibition area where entry of another unmanned haul vehicle 10 and the unmanned sprinkler vehicle 20 traveling around the unmanned haul vehicle 10 is prohibited. The protection area 103 is set in the moving direction of the unmanned haul vehicle 10. When the unmanned haul vehicle 10 moves forward, at least a part of the protection area 103 is set in front of the unmanned haul vehicle 10. The protection area 103 is set in a band shape so as to include the traveling course 102. In addition, the protection area 103 is set to include the unmanned haul vehicle 10. A length of the protection area 103 in the moving direction of the unmanned haul vehicle 10 is, for example, 20 [m] or more and 500 [m] or less.

A stop point 104 of the unmanned haul vehicle 10 is set inside the protection area 103. The stop point 104 is set at a leading end portion of the protection area 103. The traveling speed of the unmanned haul vehicle 10 is controlled so that the unmanned haul vehicle 10 can stop at the stop point 104.

The first protection area setting unit 63 sequentially updates the protection area 103 as the unmanned haul vehicle 10 moves. The first protection area setting unit 63 sequentially releases the protection area 103 where the unmanned haul vehicle 10 has passed. The first protection area setting unit 63 sequentially expands the protection area 103 where the unmanned haul vehicle 10 has not passed in the moving direction of the unmanned haul vehicle 10. When the protection area 103 where the unmanned haul vehicle 10 has passed is released, another unmanned haul vehicle 10 and the unmanned sprinkler vehicle 20 can travel. When the protection area 103 where the unmanned haul vehicle 10 has not passed is expanded, the unmanned haul vehicle 10 continues to move. When an event that the protection area 103 cannot be expanded occurs, the unmanned haul vehicle 10 stops at the stop point 104. As the event that the protection area 103 cannot be expanded, an event in which another unmanned haul vehicle 10 or the unmanned sprinkler vehicle 20 is stopped in front of the protection area 103 is exemplified.

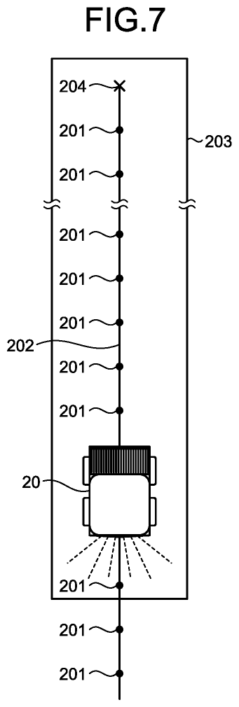

FIG. 7 is a diagram for describing second course data and the protection area 203 of the unmanned sprinkler vehicle 20 according to the embodiment. The second course data defines a traveling condition of the unmanned sprinkler vehicle 20. The second course data includes course points 201, a traveling course 202, a target position of the unmanned sprinkler vehicle 20, a target orientation of the unmanned sprinkler vehicle 20, and a target traveling speed of the unmanned sprinkler vehicle 20.

A plurality of course points 201 is set on the traveling path 36 including the intersections 37. In addition, the plurality of course points 201 is set in each of the loading area 31, the discharging area 32, the parking area 33, the fuel supply area 34, and the water supply area 35. The course points 201 define the target position of the unmanned sprinkler vehicle 20. The target orientation and target traveling speed of the unmanned sprinkler vehicle 20 are set for each of the plurality of course points 201. The plurality of course points 201 is set at intervals. The intervals between the course points 201 are set to, for example, 1 [m] or more and 5 [m] or less. The intervals between the course points 201 may be uniform or non-uniform.

The traveling course 202 refers to a virtual line indicating a target traveling path of the unmanned sprinkler vehicle 20. The traveling course 202 is defined by a trajectory passing through the plurality of course points 201. The unmanned sprinkler vehicle 20 travels at the work site along the traveling course 202.

The target position of the unmanned sprinkler vehicle 20 refers to a target position of the unmanned sprinkler vehicle 20 when passing through the course point 201. The target position of the unmanned sprinkler vehicle 20 may be defined in a local coordinate system of the unmanned sprinkler vehicle 20 or may be defined in a global coordinate system.

The target orientation of the unmanned sprinkler vehicle 20 refers to a target orientation of the unmanned sprinkler vehicle 20 when passing through the course point 201.

The target traveling speed of the unmanned sprinkler vehicle 20 refers to a target traveling speed of the unmanned sprinkler vehicle 20 when passing through the course point 201. The target traveling speed of the unmanned sprinkler vehicle 20 includes an upper limit speed (limit speed) indicating an upper limit of the traveling speed of the unmanned sprinkler vehicle 20. The unmanned sprinkler vehicle 20 travels at a traveling speed not exceeding the upper limit speed at the work site.

The protection area 203 is an area where the unmanned sprinkler vehicle 20 is permitted to travel. In addition, the protection area 203 is an area where entry of another unmanned sprinkler vehicle 20 and the unmanned haul vehicle 10 traveling around the unmanned sprinkler vehicle 20 is prohibited. That is, the protection area 203 functions as a permission area in which the unmanned sprinkler vehicle 20 is permitted to travel. The protection area 203 functions as an entry prohibition area where entry of another unmanned sprinkler vehicle 20 and the unmanned haul vehicle 10 traveling around the unmanned sprinkler vehicle 20 is prohibited. The protection area 203 is set in the moving direction of the unmanned sprinkler vehicle 20. When the unmanned sprinkler vehicle 20 moves forward, at least a part of the protection area 203 is set in front of the unmanned sprinkler vehicle 20. The protection area 203 is set in a band shape so as to include the traveling course 202. In addition, the protection area 203 is set to include the unmanned sprinkler vehicle 20. A length of the protection area 203 in the moving direction of the unmanned sprinkler vehicle 20 is, for example, 20 [m] or more and 500 [m] or less.

A stop point 204 of the unmanned sprinkler vehicle 20 is set inside the protection area 203. The stop point 204 is set at a leading end portion of the protection area 203. The traveling speed of the unmanned sprinkler vehicle 20 is controlled so that the unmanned sprinkler vehicle 20 can stop at the stop point 204.

The second protection area setting unit 64 sequentially updates the protection area 203 as the unmanned sprinkler vehicle 20 moves. The second protection area setting unit 64 sequentially releases the protection area 203 where the unmanned sprinkler vehicle 20 has passed. The second protection area setting unit 64 sequentially expands the protection area 203 where the unmanned sprinkler vehicle 20 has not passed in the moving direction of the unmanned sprinkler vehicle 20. When the protection area 203 where the unmanned sprinkler vehicle 20 has passed is released, another unmanned sprinkler vehicle 20 and the unmanned haul vehicle 10 can travel. When the protection area 203 where the unmanned sprinkler vehicle 20 has not passed is expanded, the unmanned sprinkler vehicle 20 continues to move. When an event that the protection area 203 cannot be expanded occurs, the unmanned sprinkler vehicle 20 stops at the stop point 204. As the event that the protection area 203 cannot be expanded, an event in which another unmanned sprinkler vehicle 20 or the unmanned haul vehicle 10 is stopped in front of the protection area 203 is exemplified.

The first protection area setting unit 63 sets the protection area 103 for each of the plurality of unmanned haul vehicles 10 operating at the work site. The second protection area setting unit 64 sets the protection area 203 for each of the plurality of unmanned sprinkler vehicle 20 operating at the work site. The first protection area setting unit 63 sets the protection areas 103 so that the plurality of protection areas 103 do not overlap each other. The second protection area setting unit 64 sets the protection areas 203 so that the plurality of protection areas 203 do not overlap each other. The first protection area setting unit 63 and the second protection area setting unit 64 set the protection area 103 and the protection area 203 so that the protection area 103 and the protection area 203 do not overlap each other.

The second protection area setting unit 64 sets the protection area 203 where entry of the unmanned vehicle (another unmanned sprinkler vehicle 20 and the unmanned haul vehicle 10) traveling around the unmanned sprinkler vehicle 20 is prohibited on the basis of the sprinkling state of the sprinkle spray 28 provided in the unmanned sprinkler vehicle 20 moving at the work site.

The sprinkling data generation unit 65 generates sprinkling data for controlling the sprinkle spray 28. The sprinkling data includes at least one of execution of sprinkling and stop of sprinkling from the sprinkle spray 28, a sprinkling position where the sprinkle spray 28 sprinkles water at the work site, and a sprinkling amount per unit area from the sprinkle spray 28. The sprinkling position where the sprinkle spray 28 sprinkles water includes a sprinkling area indicating an area in the traveling path 36 (work site) to be sprinkled by the sprinkle spray 28. In addition, in a case where a plurality of sprinkle sprays 28 is provided in the unmanned sprinkler vehicle 20, the sprinkling data includes the number of sprinkle sprays 28 that execute sprinkling. In addition, in a case where the sprinkle spray 28 is installed at each of a plurality of positions of the unmanned sprinkler vehicle 20, the sprinkling data includes the installation positions of the sprinkle sprays 28 that execute sprinkling. The sprinkling data generation unit 65 may generate the sprinkling data on the basis of the input data from the input device 9.

The sprinkling state of the sprinkle spray 28 is defined according to the sprinkling data. The second protection area setting unit 64 can acquire the sprinkling state of the sprinkle spray 28 by acquiring the sprinkling data generated by the sprinkling data generation unit 65.

The first output unit 66 outputs the first course data generated by the first course data generation unit 61 to the unmanned haul vehicle 10. The first output unit 66 transmits the first course data from the communication interface 41 to the control device 11 of the unmanned haul vehicle 10.

The first output unit 66 outputs each of the protection area 103 set by the first protection area setting unit 63 and the protection area 203 set by the second protection area setting unit 64 to the unmanned haul vehicle 10. The first output unit 66 transmits the protection area 103 and the protection area 203 from the communication interface 41 to the control device 11 of the unmanned haul vehicle 10.

The second output unit 67 outputs the second course data generated by the second course data generation unit 62 to the unmanned sprinkler vehicle 20. The second output unit 67 transmits the second course data from the communication interface 41 to the control device 21 of the unmanned sprinkler vehicle 20.

The second output unit 67 outputs each of the protection area 203 set by the second protection area setting unit 64 and the protection area 103 set by the first protection area setting unit 63 to the unmanned sprinkler vehicle 20. The second output unit 67 transmits the protection area 203 and the protection area 103 from the communication interface 41 to the control device 21 of the unmanned sprinkler vehicle 20.

The second output unit 67 outputs the sprinkling data generated by the sprinkling data generation unit 65 to the unmanned sprinkler vehicle 20. The second output unit 67 transmits the sprinkling data from the communication interface 41 to the control device 21 of the unmanned sprinkler vehicle 20.

The control device 11 includes a computer system. Similarly to the management device 2, the control device 11 includes a communication interface, a storage circuit, and a processing circuit. The control device 11 includes a traveling control unit 71 that controls the traveling device 13. The traveling control unit 71 controls the traveling device 13 on the basis of the first course data, the protection area 103, and the protection area 203 transmitted from the management device 2.

The control device 21 includes a computer system. Similarly to the management device 2, the control device 21 includes a communication interface, a storage circuit, and a processing circuit. The control device 21 includes a traveling control unit 81 that controls the traveling device 23 and a sprinkling control unit 82 that controls the sprinkle spray 28. The traveling control unit 81 controls the traveling device 23 on the basis of the second course data, the protection area 203, and the protection area 103 transmitted from the management device 2. The sprinkling control unit 82 controls the sprinkle spray 28 on the basis of the sprinkling data transmitted from the management device 2.

The traveling control unit 71 controls the traveling device 13 on the basis of the first course data and the detection data of the sensor system 15. The traveling control unit 71 controls the traveling device 13 so that the unmanned haul vehicle 10 travels along the traveling course 102 on the basis of the detection data of the position sensor 15A and the detection data of the orientation sensor 15B.

That is, the traveling control unit 71 controls the traveling device 13 so that the deviation between the detection position of the unmanned haul vehicle 10 detected by the position sensor 15A when passing through the course point 101 and the target position of the unmanned haul vehicle 10 set at the course point 101 becomes small.

In addition, the traveling control unit 71 controls the traveling device 13 so that the deviation between the detection orientation of the unmanned haul vehicle 10 detected by the orientation sensor 15B when passing through the course point 101 and the target orientation of the unmanned haul vehicle 10 set at the course point 101 becomes small.

In addition, the traveling control unit 71 controls the traveling device 13 so that the unmanned haul vehicle 10 travels at the target traveling speed on the basis of the detection data of the speed sensor 15C. That is, the traveling control unit 71 controls the traveling device 13 so that the deviation between the detection traveling speed of the unmanned haul vehicle 10 detected by the speed sensor 15C when passing through the course point 101 and the target traveling speed of the unmanned haul vehicle 10 set at the course point 101 becomes small.

As described above, the target traveling speed of the unmanned haul vehicle 10 includes an upper limit speed of the unmanned haul vehicle 10. The traveling control unit 71 controls the traveling device 13 so that the unmanned haul vehicle 10 travels at a traveling speed not exceeding the upper limit speed on the basis of the detection data of the speed sensor 15C. That is, the traveling control unit 71 controls the traveling device 13 so that the detection traveling speed of the unmanned haul vehicle 10 detected by the speed sensor 15C when passing through the course point 101 does not exceed the upper limit speed of the unmanned haul vehicle 10 set at the course point 101.

In addition, the traveling control unit 71 controls the traveling device 13 on the basis of the protection area 103 and the protection area 203 transmitted from the management device 2. As described above, when an event that the protection area 103 cannot be expanded occurs, the traveling control unit 71 controls the traveling device 13 so that the unmanned haul vehicle 10 stops at the stop point 104. The traveling control unit 71 controls the traveling device 13 so that the unmanned haul vehicle 10 does not enter the inside of the protection area 203 set for the unmanned sprinkler vehicle 20.

The traveling control unit 81 controls the traveling device 23 on the basis of the second course data and the detection data of the sensor system 25. The traveling control unit 81 controls the traveling device 23 so that the unmanned sprinkler vehicle 20 travels along the traveling course 202 on the basis of the detection data of the position sensor 25A and the detection data of the orientation sensor 25B.

That is, the traveling control unit 81 controls the traveling device 23 so that the deviation between the detection position of the unmanned sprinkler vehicle 20 detected by the position sensor 25A when passing through the course point 201 and the target position of the unmanned sprinkler vehicle 20 set at the course point 201 becomes small.

In addition, the traveling control unit 81 controls the traveling device 23 so that the deviation between the detection orientation of the unmanned sprinkler vehicle 20 detected by the orientation sensor 25B when passing through the course point 201 and the target orientation of the unmanned sprinkler vehicle 20 set at the course point 201 becomes small.

In addition, the traveling control unit 81 controls the traveling device 23 so that the unmanned sprinkler vehicle 20 travels at the target traveling speed on the basis of the detection data of the speed sensor 25C. That is, the traveling control unit 81 controls the traveling device 23 so that the deviation between the detection traveling speed of the unmanned sprinkler vehicle 20 detected by the speed sensor 25C when passing through the course point 201 and the target traveling speed of the unmanned sprinkler vehicle 20 set at the course point 201 becomes small.

As described above, the target traveling speed of the unmanned sprinkler vehicle 20 includes an upper limit speed of the unmanned sprinkler vehicle 20. The traveling control unit 81 controls the traveling device 23 so that the unmanned sprinkler vehicle 20 travels at a traveling speed not exceeding the upper limit speed on the basis of the detection data of the speed sensor 25C. That is, the traveling control unit 81 controls the traveling device 23 so that the detection traveling speed of the unmanned sprinkler vehicle 20 detected by the speed sensor 25C when passing through the course point 201 does not exceed the upper limit speed of the unmanned sprinkler vehicle 20 set at the course point 201.

In addition, the traveling control unit 81 controls the traveling device 23 on the basis of the protection area 203 and the protection area 103 transmitted from the management device 2. As described above, when an event that the protection area 203 cannot be expanded occurs, the traveling control unit 81 controls the traveling device 23 so that the unmanned sprinkler vehicle 20 stops at the stop point 204. The traveling control unit 81 controls the traveling device 23 so that the unmanned sprinkler vehicle 20 does not enter the inside of the protection area 103 set for the unmanned haul vehicle 10.

The sprinkling control unit 82 controls the sprinkle spray 28 on the basis of the sprinkling data transmitted from the management device 2. The sprinkling state of the sprinkle spray is defined according to the sprinkling data.

[Sprinkling State of Sprinkle Spray]

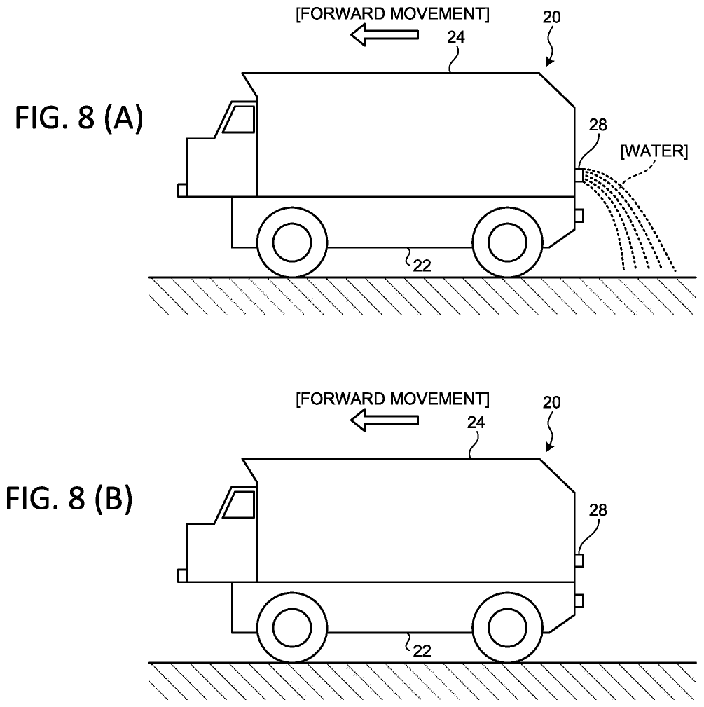

FIG. 8 is a diagram for describing a sprinkling state of the sprinkle spray 28 according to the embodiment. As illustrated in FIG. 8, the sprinkle spray 28 is disposed at a rear portion of the unmanned sprinkler vehicle 20. The sprinkle spray 28 sprinkles water behind the unmanned sprinkler vehicle 20 when the unmanned sprinkler vehicle 20 moves forward.

The sprinkling control unit 82 controls the sprinkle spray 28 on the basis of the sprinkling data transmitted from the management device 2. The sprinkling state of the sprinkle spray is defined according to the sprinkling data.

The sprinkling state of the sprinkle spray 28 includes execution of sprinkling and stop of sprinkling by the sprinkle spray 28. FIG. 8(A) illustrates a state in which sprinkling by the sprinkle spray 28 is being executed. FIG. 8(B) illustrates a state in which sprinkling by the sprinkle spray 28 is stopped.

[Processing of Second Protection Area Setting Unit]

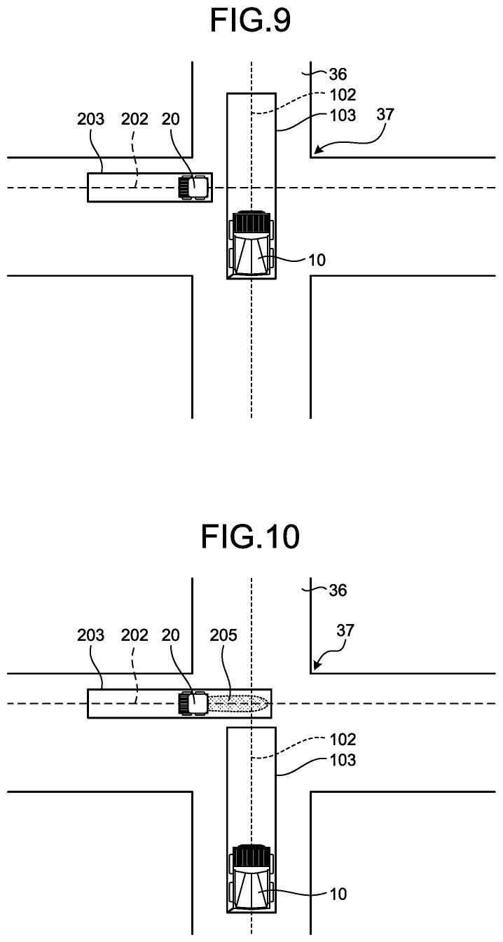

Each of FIGS. 9 and 10 is a diagram for describing processing of the second protection area setting unit 64 according to the embodiment. FIG. 9 illustrates the protection area 203 that is set when the sprinkling by the sprinkle spray 28 is stopped. FIG. 10 illustrates the protection area 203 that is set when the sprinkling by the sprinkle spray 28 is being executed.

As illustrated in FIGS. 9 and 10, the second protection area setting unit 64 sets the protection area 203 so as to include the unmanned sprinkler vehicle 20.

As illustrated in FIGS. 9 and 10, the second protection area setting unit 64 sets the protection area 203 so that the protection area 203 when the sprinkling by the sprinkle spray 28 is being executed is larger than the protection area 203 when the sprinkling by the sprinkle spray 28 is stopped.

As illustrated in FIG. 9, when the sprinkling by the sprinkle spray 28 is stopped, the second protection area setting unit 64 sets the protection area 203 so that a rear end portion of the unmanned sprinkler vehicle 20 and a rear end portion of the protection area 203 substantially coincide with each other.

As illustrated in FIG. 10, when the sprinkling by the sprinkle spray 28 is being executed, the second protection area setting unit 64 sets the protection area 203 so as to include a sprinkling area 205 indicating an area sprinkled by the sprinkle spray 28. That is, when the sprinkling by the sprinkle spray 28 is being executed, the second protection area setting unit 64 enlarges the protection area 203 more than when the sprinkling by the sprinkle spray 28 is stopped so that the sprinkling area is disposed inside the protection area 203. The second protection area setting unit 64 extends the rear end portion of the protection area 203 rearward of the unmanned sprinkler vehicle 20 as compared with when the sprinkling by the sprinkle spray 28 is stopped. The second protection area setting unit 64 extends the rear end portion of the protection area 203 rearward so that the unmanned haul vehicle 10 does not enter the sprinkling area 205.

Note that the dimensions of the protection area 203 defined in front of the unmanned sprinkler vehicle 20 are the same in each of a case where the sprinkling by the sprinkle spray 28 is being executed and a case where the sprinkling is stopped. That is, the distance between a front end portion of the unmanned sprinkler vehicle 20 and a front end portion of the protection area 203 when the sprinkling by the sprinkle spray 28 is stopped is equal to the distance between the front end portion of the unmanned sprinkler vehicle 20 and the front end portion of the protection area 203 when the sprinkling by the sprinkle spray 28 is being executed. Note that the distance between the front end portion of the unmanned sprinkler vehicle 20 and the front end portion of the protection area 203 when the sprinkling by the sprinkle spray 28 is stopped may be different from the distance between the front end portion of the unmanned sprinkler vehicle 20 and the front end portion of the protection area 203 when the sprinkling by the sprinkle spray 28 is being executed.

When the sprinkling by the sprinkle spray 28 is being executed, the protection area 203 is set to include the sprinkling area 205. As a result, the unmanned haul vehicle 10 traveling around the unmanned sprinkler vehicle 20 is suppressed from entering the sprinkling area 205. That is, traveling of the unmanned haul vehicle 10 on the road surface immediately after the sprinkling is suppressed. When traveling on the road surface immediately after the sprinkling, there is a high possibility that the tires 17 of the unmanned haul vehicle 10 skid, and there is a possibility that traveling of the unmanned haul vehicle 10 is hindered. In the embodiment, when the sprinkling by the sprinkle spray 28 is being executed, the protection area 203 is set so as to include the sprinkling area 205, and entry of the unmanned haul vehicle 10 into the sprinkling area 205 is prohibited, so that skidding of the tires 17 of the unmanned haul vehicle 10 is suppressed. Therefore, the unmanned haul vehicle 10 can travel smoothly.

In addition, in a case where the sprinkling by the sprinkle spray 28 is being executed, entry of the unmanned haul vehicle 10 into the sprinkling area 205 is prohibited, so that the water sprayed from the sprinkle spray 28 is suppressed from being splashed on the obstacle sensor 15D provided in the unmanned haul vehicle 10. Therefore, a decrease in detection accuracy of the obstacle sensor 15D is suppressed.

As described above, in a case where the sprinkling by the sprinkle spray 28 is being executed, the protection area 203 is set so as to include the sprinkling area 205, and the traveling device 13 of the unmanned haul vehicle 10 is controlled so that the unmanned haul vehicle 10 does not enter the sprinkling area 205. As a result, the tires 17 of the unmanned haul vehicle 10 are suppressed from skidding, and the unmanned haul vehicle 10 can travel smoothly.

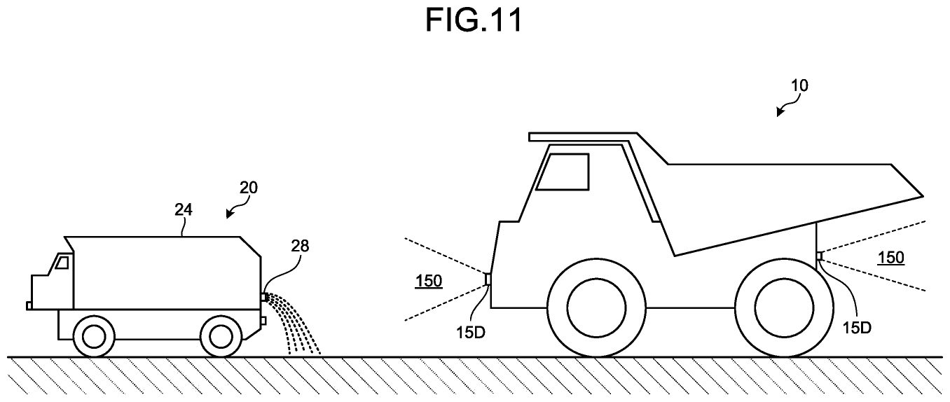

FIG. 11 is a diagram illustrating a relationship between the unmanned sprinkler vehicle 20 and the unmanned haul vehicle 10 according to the embodiment. As illustrated in FIG. 11, the obstacle sensor 15D of the unmanned haul vehicle 10 is attached to each of the front portion of the unmanned haul vehicle 10 and the rear portion of the unmanned haul vehicle 10. A detection area 150 of the obstacle sensor 15D attached to the front portion of the unmanned haul vehicle 10 is defined in front of the unmanned haul vehicle 10. A detection area 150 of the obstacle sensor 15D attached to the rear portion of the unmanned haul vehicle 10 is defined behind the unmanned haul vehicle 10. The obstacle sensor 15D detects an obstacle present in the detection area 150.

As illustrated in FIG. 11, when the water sprayed from the sprinkle spray 28 is splashed on the obstacle sensor 15D provided in the unmanned haul vehicle 10 or enters the detection area 150 of the obstacle sensor 15D, there is a possibility that the detection accuracy of the obstacle sensor 15D decreases. In the embodiment, in a case where the sprinkling by the sprinkle spray 28 is being executed, the protection area 203 is set so as to include the sprinkling area 205, and the traveling device 13 of the unmanned haul vehicle 10 is controlled so that the unmanned haul vehicle 10 does not enter the sprinkling area 205. Thus, since the water sprayed from the sprinkle spray 28 is suppressed from being splashed on the obstacle sensor 15D provided in the unmanned haul vehicle 10 or entering the detection area 150 of the obstacle sensor 15D, a decrease in detection accuracy of the obstacle sensor 15D is suppressed.

For example, when the sprinkling by the sprinkle spray 28 is stopped and the unmanned haul vehicle 10 travels behind the unmanned sprinkler vehicle 20, in a case where the sprinkling by the sprinkle spray 28 is started, the protection area 203 is enlarged. The protection area 203 is enlarged so as to change from the state illustrated in FIG. 9 to the state illustrated in FIG. 10. The traveling control unit 71 of the unmanned haul vehicle 10 controls the traveling device 13 so that the unmanned haul vehicle 10 does not enter the protection area 203.

For example, when the sprinkling by the sprinkle spray 28 is executed and the unmanned haul vehicle 10 is controlled not to travel behind the unmanned sprinkler vehicle 20, in a case where the sprinkling by the sprinkle spray 28 is stopped, the protection area 203 is reduced. The protection area 203 is reduced so as to change from the state illustrated in FIG. 10 to the state illustrated in FIG. 9. The traveling control unit 71 of the unmanned haul vehicle 10 can control the traveling device 13 so that the unmanned haul vehicle 10 passes behind the unmanned sprinkler vehicle 20.

[Unmanned Vehicle Management Method]

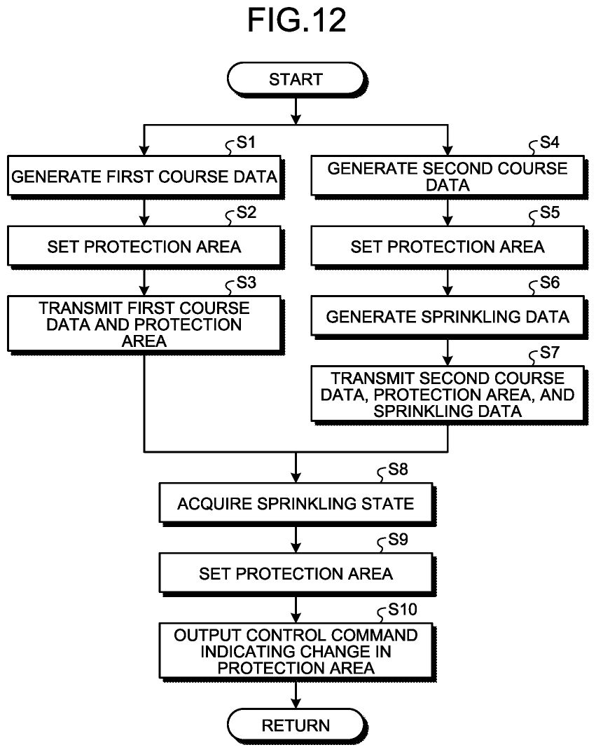

FIG. 12 is a flowchart illustrating an unmanned vehicle management method according to the embodiment.

The first course data generation unit 61 generates the first course data of the unmanned haul vehicle 10 (Step S1).

The first protection area setting unit 63 sets the protection area 103 of the unmanned haul vehicle 10 (Step S2).

Note that the processing of Step S2 may be executed before the processing of Step S1, or the processing of Step S2 may be executed in parallel with at least a part of the processing of Step S1.

The first output unit 66 transmits the first course data generated by the first course data generation unit 61 and the protection area 103 set by the first protection area setting unit 63 to the unmanned haul vehicle 10 (Step S3).

The unmanned haul vehicle 10 travels on the traveling path 36 on the basis of the first course data and the protection area 103.

The second course data generation unit 62 generates the second course data of the unmanned sprinkler vehicle 20 (Step S4).

In addition, the second protection area setting unit 64 sets the protection area 203 of the unmanned sprinkler vehicle 20 (Step S5).

The sprinkling data generation unit 65 generates sprinkling data for the sprinkle spray 28 (Step S6).

Note that the processing of Step S4, the processing of Step S5, and the processing of Step S6 may be executed in any order.

The second output unit 67 transmits the second course data generated by the second course data generation unit 62, the protection area 203 set by the second protection area setting unit 64, and the sprinkling data generated by the sprinkling data generation unit 65 to the unmanned sprinkler vehicle 20 (Step S7).

The unmanned sprinkler vehicle 20 travels on the traveling path 36 on the basis of the second course data and the protection area 203. In addition, the sprinkle spray 28 executes sprinkling or stops sprinkling on the basis of the sprinkling data.

The second protection area setting unit 64 acquires the sprinkling state of the sprinkle spray 28 (Step S8).

The sprinkling state of the sprinkle spray 28 is defined according to the sprinkling data generated by the sprinkling data generation unit 65. The second protection area setting unit 64 can acquire the sprinkling state of the sprinkle spray 28 by acquiring the sprinkling data generated by the sprinkling data generation unit 65.

The second protection area setting unit 64 sets the size of the protection area 203 on the basis of the sprinkling state of the sprinkle spray 28 (Step S9).

As described with reference to FIG. 9, when the sprinkling by the sprinkle spray 28 is stopped, the second protection area setting unit 64 reduces the dimensions of the protection area 203 defined behind the unmanned sprinkler vehicle 20. That is, in a case where the sprinkling by the sprinkle spray 28 is stopped, the second protection area setting unit 64 sets the protection area 203 so that the rear end portion of the unmanned sprinkler vehicle 20 and the rear end portion of the protection area 203 substantially coincide with each other.

As described with reference to FIG. 10, when the sprinkling by the sprinkle spray 28 is being executed, the second protection area setting unit 64 enlarges the dimensions of the protection area 203 defined behind the unmanned sprinkler vehicle 20. That is, in a case where the sprinkling by the sprinkle spray 28 is being executed, the second protection area setting unit 64 sets the protection area 203 so that the sprinkling area 205 indicating the area sprinkled by the sprinkle spray 28 is included in the protection area 203. The second protection area setting unit 64 enlarges the protection area 203 so that the rear end portion of the protection area 203 moves rearward beyond the rear end portion of the unmanned sprinkler vehicle 20.

The second output unit 67 transmits the protection area 203 set in Step S9 to the unmanned sprinkler vehicle 20. When the size of the protection area 203 is changed in Step S9, the second output unit 67 outputs a control command indicating the change in the protection area 203 to the unmanned sprinkler vehicle 20 (Step S10).

The traveling control unit 71 of the unmanned haul vehicle 10 controls the traveling device 13 so as to prevent entry into the protection area 203.

[Effects]

As described above, according to the embodiment, the protection area 203 where entry of the unmanned haul vehicle 10 traveling around the unmanned sprinkler vehicle 20 is prohibited is set on the basis of the sprinkling state of the sprinkle spray 28.

In a case where the sprinkling by the sprinkle spray 28 is being executed, the protection area 203 is set so as to include the sprinkling area 205, and the unmanned haul vehicle 10 is suppressed from entering the sprinkling area 205. Thus, the tires 17 of the unmanned haul vehicle 10 are suppressed from skidding, and the unmanned haul vehicle 10 can move forward smoothly. In addition, in a case where the sprinkling by the sprinkle spray 28 is being executed, the protection area 203 is set so as to include the sprinkling area 205, and the unmanned haul vehicle 10 is suppressed from entering the sprinkling area 205. Thus, the water sprayed from the sprinkle spray 28 is suppressed from being splashed on the obstacle sensor 15D provided at the front portion of the unmanned haul vehicle 10 or entering the detection area 150 of the obstacle sensor 15D. Thus, a decrease in detection accuracy of the obstacle sensor 15D is suppressed.

When the sprinkling by the sprinkle spray 28 is stopped, the protection area 203 is reduced. When the sprinkling by the sprinkle spray 28 is stopped, the protection area 203 is reduced, so that the traveling of the unmanned haul vehicle 10 is suppressed from being unnecessarily restricted. Thus, the effect of the unmanned sprinkler vehicle 20 during sprinkling on the surrounding unmanned haul vehicle 10 is suppressed. In addition, the unmanned haul vehicle 10 can smoothly travel on the traveling path 36, and a decrease in productivity at the work site is suppressed.

### Other Embodiments

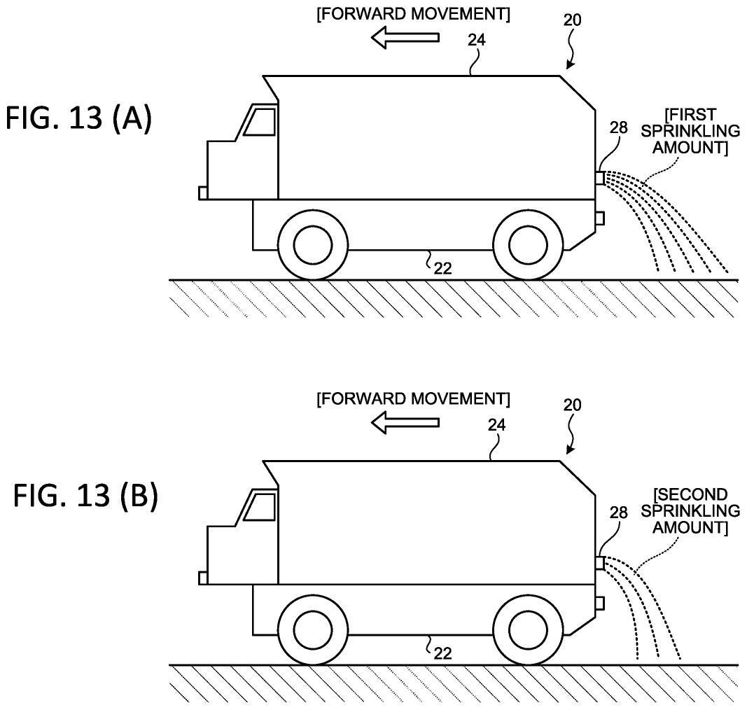

FIG. 13 is a diagram for describing a sprinkling state of the sprinkle spray 28 according to the embodiment. In the above-described embodiment, the sprinkling state of the sprinkle spray 28 includes execution of sprinkling and stop of sprinkling by the sprinkle spray 28. As illustrated in FIG. 13, the sprinkling state of the sprinkle spray 28 may include the sprinkling amount from the sprinkle spray 28. The sprinkling amount refers to a sprinkling amount per unit area sprayed from the sprinkle spray 28. As illustrated in FIG. 13(A), the sprinkling control unit 82 can control the sprinkle spray 28 so that the water is sprinkled from the sprinkle spray 28 with a first sprinkling amount. As illustrated in FIG. 13(B), the sprinkling control unit 82 can control the sprinkle spray 28 so that the water is sprinkled from the sprinkle spray 28 with a second sprinkling amount smaller than the first sprinkling amount.

The second protection area setting unit 64 sets the protection area 203 so that the protection area 203 when the water is sprinkled from the sprinkle spray 28 with the first sprinkling amount is larger than the protection area 203 when the water is sprinkled with the second sprinkling amount smaller than the first sprinkling amount.

In a case where the water is sprinkled from the sprinkle spray 28 with the first sprinkling amount, the water sprinkled from the sprinkle spray 28 is sprayed far from the unmanned sprinkler vehicle 20. The second protection area setting unit 64 enlarges the protection area 203 defined behind the unmanned sprinkler vehicle 20 rearward so that the sprinkling area 205 is included in the protection area 203 when the water is sprinkled from the sprinkle spray 28 with the first sprinkling amount. By enlarging the protection area 203, the unmanned haul vehicle 10 is suppressed from entering the sprinkling area 205. As a result, the tires 17 of the unmanned haul vehicle 10 are suppressed from skidding, and the unmanned haul vehicle 10 can move forward smoothly. In addition, in a case where the water is sprinkled from the sprinkle spray 28 with the first sprinkling amount, the protection area 203 is enlarged, and the water sprayed from the sprinkle spray 28 is suppressed from being splashed on the obstacle sensor 15D provided at the front portion of the unmanned haul vehicle 10 or entering the detection area 150 of the obstacle sensor 15D. Thus, a decrease in detection accuracy of the obstacle sensor 15D is suppressed.

In a case where the water is sprinkled from the sprinkle spray 28 with the second sprinkling amount, the water sprinkled from the sprinkle spray 28 is suppressed from being sprayed far from the unmanned sprinkler vehicle 20. The second protection area setting unit 64 makes the protection area 203 smaller when the water is sprinkled from the sprinkle spray 28 with the second sprinkling amount than when the water is sprinkled from the sprinkle spray 28 with the first sprinkling amount. That is, the second protection area setting unit 64 reduces the protection area 203 defined behind the unmanned sprinkler vehicle 20. The second protection area setting unit 64 sets the protection area 203 so that the sprinkling area 205 is included in the protection area 203. In a case where the water is sprinkled from the sprinkle spray 28 with the second sprinkling amount, the protection area 203 is suppressed from becoming unnecessarily large. Since the protection area 203 is suppressed from becoming unnecessarily large, the traveling of the unmanned haul vehicle 10 is suppressed from being unnecessarily restricted. The unmanned haul vehicle 10 can smoothly travel on the traveling path 36, and a decrease in productivity at the work site is suppressed.

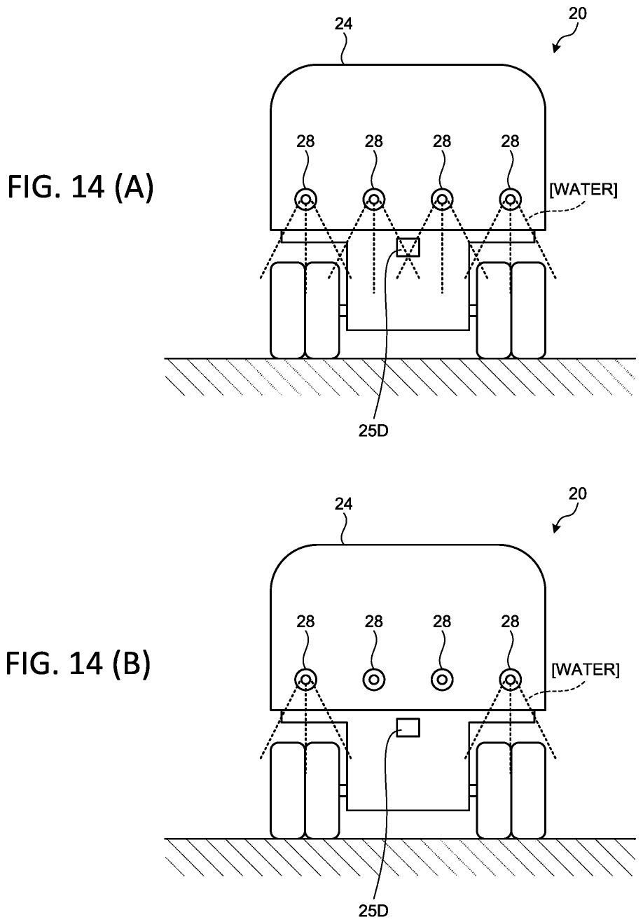

FIG. 14 is a diagram for describing a sprinkling state of the sprinkle spray 28 according to the embodiment. As illustrated in FIG. 14, a plurality of sprinkle sprays 28 is disposed at the rear portion of the unmanned sprinkler vehicle 20. The sprinkle spray 28 is installed at each of a plurality of positions in the vehicle width direction of the unmanned sprinkler vehicle 20 at the rear portion of the unmanned sprinkler vehicle 20. In the example illustrated in FIG. 14, the plurality of sprinkle sprays 28 is disposed at intervals in the vehicle width direction at the rear portion of the unmanned sprinkler vehicle 20. The obstacle sensor 25D is disposed at a central portion in the vehicle width direction.

The sprinkling state of the sprinkle spray 28 includes the number of sprinkle sprays 28 that execute the sprinkling. In addition, the sprinkling state of the sprinkle spray 28 includes the installation position of the sprinkle sprays 28 that execute the sprinkling. As illustrated in FIG. 14(A), the sprinkling control unit 82 can control the sprinkle sprays 28 so that the water is sprinkled from a first number of sprinkle sprays 28. In the example illustrated in FIG. 14(A), the first number is four. In addition, the sprinkling control unit 82 can control the sprinkle sprays 28 so that the water is at least sprinkled from the sprinkle spray 28 installed at the central portion in the vehicle width direction of the unmanned sprinkler vehicle 20. As illustrated in FIG. 14(B), the sprinkling control unit 82 can control the sprinkle sprays 28 so that the water is sprinkled from a second number of sprinkle sprays 28, the second number being smaller than the first number. In the example illustrated in FIG. 14(B), the second number is two. In addition, the sprinkling control unit 82 can control the sprinkle sprays 28 so that the water is sprinkled from the sprinkle spray 28 installed at an end portion in the vehicle width direction of the unmanned sprinkler vehicle 20.

The second protection area setting unit 64 sets the protection area 203 so that the protection area 203 when the water is sprinkled from the first number of sprinkle sprays 28 is different from the protection area 203 when the water is sprinkled with the second number of sprinkle sprays 28, the second number being smaller than the first number.

There is a possibility that the sprinkling area 205 is larger when the water is sprinkled from the first number of sprinkle sprays 28 than when the water is sprinkled from the second number of sprinkle sprays 28. In this case, the second protection area setting unit 64 sets the protection area 203 so that the protection area 203 when the water is sprinkled from the first number of sprinkle sprays 28 is larger than the protection area 203 when the water is sprinkled with the second number of sprinkle sprays 28, the second number being smaller than the first number.

In a case where the water is sprinkled from the first number of sprinkle sprays 28, the protection area 203 is set to be large so as to include the sprinkling area 205, so that the tires 17 of the unmanned haul vehicle 10 are suppressed from skidding and the unmanned haul vehicle 10 can move forward smoothly. In addition, in a case where the water is sprinkled from the first number of sprinkle sprays 28, the protection area 203 is set to be large so as to include the sprinkling area 205, and the water sprayed from the sprinkle sprays 28 is suppressed from being splashed on the obstacle sensor 15D provided in the unmanned haul vehicle 10 or entering the detection area 150 of the obstacle sensor 15D. Thus, a decrease in detection accuracy of the obstacle sensor 15D is suppressed.

In a case where the water is sprinkled from the second number of sprinkle sprays 28, the protection area 203 is set to be small, so that the traveling of the unmanned haul vehicle 10 is suppressed from being unnecessarily restricted. The unmanned haul vehicle 10 can smoothly travel on the traveling path 36, and a decrease in productivity at the work site is suppressed.

The second protection area setting unit 64 sets the protection area 203 so that the protection area 203 when the installation position of the sprinkle spray 28 that executes the sprinkling is the central portion in the vehicle width direction of the unmanned sprinkler vehicle 20 is different from the protection area 203 when the installation position of the sprinkle spray 28 that executes the sprinkling is the end portion in the vehicle width direction of the unmanned sprinkler vehicle 20.

In a case where the installation position of the sprinkle spray 28 that executes the sprinkling is the end portion in the vehicle width direction of the unmanned sprinkler vehicle 20, there is a possibility that the sprinkling area 205 becomes large in the vehicle width direction as compared with a case where the installation position of the sprinkle spray 28 that executes the sprinkling is the central portion in the vehicle width direction of the unmanned sprinkler vehicle 20. In that case, the second protection area setting unit 64 sets the protection area 203 so that the protection area 203 when the installation position of the sprinkle spray 28 that executes the sprinkling is the end portion in the vehicle width direction of the unmanned sprinkler vehicle 20 is larger than the protection area 203 when the installation position of the sprinkle spray 28 that executes the sprinkling is the central portion in the vehicle width direction of the unmanned sprinkler vehicle 20.

In a case where the installation position of the sprinkle spray 28 that executes the sprinkling is the end portion in the vehicle width direction of the unmanned sprinkler vehicle 20, the protection area 203 is enlarged in the vehicle width direction, so that the tires 17 of the unmanned haul vehicle 10 are suppressed from skidding and the unmanned haul vehicle 10 can move forward smoothly. In addition, the water sprayed from the sprinkle spray 28 is suppressed from being splashed on the obstacle sensor 15D provided in the unmanned haul vehicle 10 or entering the detection area 150 of the obstacle sensor 15D. Thus, a decrease in detection accuracy of the obstacle sensor 15D is suppressed.

In a case where the installation position of the sprinkle spray 28 that executes the sprinkling is the central portion in the vehicle width direction of the unmanned sprinkler vehicle 20, the protection area 203 is reduced in the vehicle width direction as compared with a case where the installation position of the sprinkle spray 28 that executes the sprinkling is the end portion in the vehicle width direction of the unmanned sprinkler vehicle 20. As a result, the traveling of the unmanned haul vehicle 10 is suppressed from being unnecessarily restricted. The unmanned haul vehicle 10 can smoothly travel on the traveling path 36, and a decrease in productivity at the work site is suppressed.

In the above-described embodiment, the first course data may not be generated. The unmanned haul vehicle 10 may travel on the traveling path 36 not on the basis of the first course data. In the above-described embodiment, the second course data may not be generated. The unmanned sprinkler vehicle 20 may travel on the traveling path 36 not on the basis of the second course data.

In the above-described embodiment, at least a part of the function of the control device 11 and the function of the control device 21 may be provided in the management device 2, or at least a part of the function of the management device 2 may be provided in one or both of the control device 11 and the control device 21. For example, in the above-described embodiment, the control device 11 may have the function of the first course data generation unit 61 and the function of the first protection area setting unit 63. The control device 21 may have the function of the second course data generation unit 62, the function of the second protection area setting unit 64, and the function of the sprinkling data generation unit 65.

In the above-described embodiment, each of the first course data generation unit 61, the second course data generation unit 62, the first protection area setting unit 63, the second protection area setting unit 64, the sprinkling data generation unit 65, the first output unit 66, and the second output unit 67 may be configured by different hardware.

In the above-described embodiment, the first unmanned vehicle 10 is an unmanned haul vehicle, and the second unmanned vehicle 20 is an unmanned sprinkler vehicle. The first unmanned vehicle 10 may be an unmanned sprinkler vehicle.

### REFERENCE SIGNS LIST

1 Management System

2 Management Device

3 Communication System

3A Wireless Communicator

3B Wireless Communicator

3C Wireless Communicator

4 Control Facility

5 Loader

6 Crusher

7 Fuel Supplier

8 Water Supplier

9 Input Device

10 Unmanned Haul Vehicle (Unmanned Vehicle)

11 Control Device

12 Vehicle Body

13 Traveling Device

14 Dump Body

15 Sensor System

15A Position Sensor

15B Orientation Sensor

15C Speed Sensor

15D Obstacle Sensor

16 Wheel

16F Front Wheel

16R Rear Wheel

17 Tire

17F Front Tire

17R Rear Tire

20 Unmanned Sprinkler Vehicle (Sprinkler Vehicle)

21 Control Device

22 Vehicle Body

23 Traveling Device

24 Tank

25 Sensor System

25A Position Sensor

25B Orientation Sensor

25C Speed Sensor

25D Obstacle Sensor

26 Wheel

26F Front Wheel

26R Rear Wheel

27 Tire

27F Front Tire

27R Rear Tire

28 Sprinkle Spray

29 Cab

31 Loading Area

32 Discharging Area

33 Parking Area

34 Fuel Supply Area

35 Water Supply Area

36 Traveling Path

37 Intersection

41 Communication Interface

42 Storage Circuit

43 Processing Circuit

61 First Course Data Generation Unit

62 Second Course Data Generation Unit

63 First Protection Area Setting Unit

64 Second Protection Area Setting Unit

65 Sprinkling Data Generation Unit

66 First Output Unit

67 Second Output Unit

71 Traveling Control Unit

81 Traveling Control Unit

82 Sprinkling Control Unit

101 Course Point

102 Traveling Course

103 Protection Area

104 Stop Point

150 Detection Area

201 Course Point

202 Traveling Course

203 Protection Area

204 Stop Point

205 Sprinkling Area

1. An unmanned vehicle management system comprising:
a protection area setting unit that sets a protection area where entry of an unmanned vehicle traveling around a sprinkler vehicle is prohibited on the basis of a sprinkling state of a sprinkle spray provided in the sprinkler vehicle moving at a work site; and
an output unit that outputs the protection area set by the protection area setting unit.

2. The unmanned vehicle management system according to claim 1, wherein
the protection area setting unit sets the protection area so as to include a sprinkling area indicating an area sprinkled by the sprinkle spray.

3. The unmanned vehicle management system according to claim 2, wherein
the protection area setting unit extends the protection area such that the unmanned vehicle does not enter the sprinkling area.

4. The unmanned vehicle management system according to claim 1, wherein
the protection area setting unit sets the protection area so as to include the sprinkler vehicle.

5. The unmanned vehicle management system according to claim 1, wherein
the sprinkle spray is disposed at a rear portion of the sprinkler vehicle, and sprinkles water behind the sprinkler vehicle when the sprinkler vehicle moves forward.

6. The unmanned vehicle management system according to claim 1, wherein
the sprinkling state includes execution of sprinkling and stop of sprinkling by the sprinkle spray, and
the protection area setting unit sets the protection area such that the protection area when the sprinkling is being executed is larger than the protection area when the sprinkling is stopped.

7. The unmanned vehicle management system according to claim 1, wherein
the sprinkling state includes a sprinkling amount from the sprinkle spray, and
the protection area setting unit sets the protection area such that the protection area when water is sprinkled with a first sprinkling amount is larger than the protection area when water is sprinkled with a second sprinkling amount smaller than the first sprinkling amount.

8. The unmanned vehicle management system according to claim 1, wherein
a plurality of the sprinkle sprays is provided,
the sprinkling state includes a number of the sprinkle sprays that execute sprinkling, and
the protection area setting unit sets the protection area such that the protection area when water is sprinkled from a first number of the sprinkle sprays is different from a protection area when water is sprinkled from a second number of the sprinkle sprays, the second number being smaller than the first number.

9. The unmanned vehicle management system according to claim 1, wherein
the sprinkle spray is installed at each of a plurality of positions in a vehicle width direction of the sprinkler vehicle,
the sprinkling state includes an installation position of the sprinkle spray that executes sprinkling, and
the protection area setting unit sets the protection area such that the protection area when the installation position is a central portion in the vehicle width direction is different from a protection area when the installation position is an end portion in the vehicle width direction.

10. The unmanned vehicle management system according to claim 1, comprising:
a traveling control unit that controls a traveling device of the unmanned vehicle, wherein
the traveling control unit controls the traveling device such that the unmanned vehicle does not enter the protection area.

11. The unmanned vehicle management system according to claim 1, wherein
the unmanned vehicle is an unmanned haul vehicle.

12. An unmanned vehicle management method comprising:
setting a protection area where entry of an unmanned vehicle traveling around a sprinkler vehicle is prohibited on the basis of a sprinkling state of a sprinkle spray provided in the sprinkler vehicle moving at a work site; and
outputting the protection area.

13. The unmanned vehicle management method according to claim 12, comprising:
controlling a traveling device of the unmanned vehicle such that the unmanned vehicle does not enter the protection area.

14. The unmanned vehicle management method according to claim 12, wherein
the protection area is set so as to include a sprinkling area indicating an area sprinkled by the sprinkle spray.

15. The unmanned vehicle management method according to claim 14, wherein
the protection area is extended such that the unmanned vehicle does not enter the sprinkling area.

16. The unmanned vehicle management method according to claim 12, wherein
the protection area is set so as to include the sprinkler vehicle.

17. The unmanned vehicle management method according to claim 12, wherein
the protection area when sprinkling by the sprinkle spray is being executed is larger than the protection area when sprinkling by the sprinkle spray is stopped.

18. The unmanned vehicle management method according to claim 12, wherein
the protection area when water is sprinkled with a first sprinkling amount from the sprinkle spray is larger than the protection area when water is sprinkled with a second sprinkling amount smaller than the first sprinkling amount.

19. The unmanned vehicle management method according to claim 12, wherein
a plurality of the sprinkle sprays is provided, and
a protection area when water is sprinkled from a first number of the sprinkle sprays is different from a protection area when water is sprinkled from a second number of the sprinkle sprays, the second number being smaller than the first number.

20. The unmanned vehicle management method according to claim 12, wherein
the sprinkle spray is installed at each of a plurality of positions in a vehicle width direction of the sprinkler vehicle, and
the protection area when an installation position of the sprinkle spray is a central portion in the vehicle width direction is different from a protection area when the installation position is an end portion in the vehicle width direction.
